(19) United States
(12) Patent Application Publication
(10) Pub. No.: US 2026/0224064 A1
(43) Pub. Date: Aug. 6, 2026

(54) BEVERAGE MACHINES AND BEVERAGE PODS

(71) Applicant: Keurig Green Mountain, Inc., Burlington, MA (US)

(72) Inventors: Neha Thatte Mallik, Reading, MA (US); Paul Angeloni, River Forest, IL (US); Blair Mikkelsen, Chicago, IL (US); Peter Jerome Warren, Park Ridge, IL (US)

(73) Assignee: Keurig Green Mountain, Inc., Burlington, MA (US)

(21) Appl. No.: 19/158,300

(22) PCT Filed: Feb. 21, 2024
(86) PCT No.: PCT/US2024/016645

§ 371 Date: Aug. 20, 2025

Related U.S. Application Data
(60) Provisional application No. 63/486,462, filed on Feb. 22, 2023.

(51) Int. Cl. A47J 31/44; A47J 31/36

(52) U.S. Cl. CPC A47J 31/4492; A47J 31/3623

(57) ABSTRACT

Aspects described herein relate to improvements in beverage machines and methods of brewing beverages therein. According to some embodiments, a beverage machine brews a beverage with a beverage pod containing beverage materials without packaging. The beverage machine identifies a brewing parameter from the size and/or deformation response of the beverage pod. According to other embodiments, a beverage pod is shaped to fit into a beverage machine in a single orientation of the beverage pod. The beverage machine scans an identifier on the beverage pod to determine a brewing parameter. The beverage machine may form beverages of different types having different brewing parameters. Determining brewing parameters enables a beverage machine to brew multiple different types of beverage.

### CROSS REFERENCE TO RELATED APPLICATION

This application claims the benefit of U.S. Provisional Application No. 63/486,462, filed Feb. 22, 2023, which is hereby incorporated by reference in its entirety.

### FIELD

The present disclosure relates to beverage making machines, such as coffee brewers that use a liquid to form a coffee beverage.

### BACKGROUND

Beverage machines are widely used to make beverages using capsules that contain ingredients, such as coffee grounds, tea leaves, and/or other soluble and/or insoluble ingredients. Such beverage machines can often be used with capsules containing a wide variety of different ingredients so as to make different beverages, such as coffee, espresso, tea, hot chocolate, flavored still drinks, flavored carbonated drinks, and so on.

### SUMMARY

According to some aspects, a beverage machine comprises a brew chamber configured to receive a beverage pod to form a beverage. The brew chamber may have a pod receptacle and a brew chamber lid. The brew chamber lid may be configured to close on the pod receptacle to encapsulate the beverage pod inside the brew chamber. Interaction of the brew chamber and beverage pod may establish a brewing parameter for the beverage machine for brewing a beverage from the beverage pod.

According to some aspects, a beverage pod comprises a body made of one or more beverage materials and a first surface. The body may have an outer wall defining an outer surface of the beverage pod. The first surface may be a planar face. The beverage pod may be asymmetric about any plane intersecting a plane containing the first surface.

According to some aspects, a method of forming a beverage comprises inserting a beverage pod into a beverage machine, closing a brew chamber lid on the beverage machine, determining a physical dimension of the beverage pod, and brewing a beverage with a brewing parameter associated with the physical dimension of the beverage pod.

It should be appreciated that the foregoing concepts, and additional concepts discussed below, may be arranged in any suitable combination, as the present disclosure is not limited in this respect. Further, other advantages and novel features of the present disclosure will become apparent from the following detailed description of various non-limiting embodiments when considered in conjunction with the accompanying figures.

### BRIEF DESCRIPTION OF DRAWINGS

The accompanying drawings are not intended to be drawn to scale. In the drawings, each identical or nearly identical component that is illustrated in various figures may be represented by a like numeral. For purposes of clarity, not every component may be labeled in every drawing. In the drawings:

FIG. 1 shows a front view of a beverage machine according to some embodiments;

FIG. 2 shows a spherical beverage pod according to some embodiments;

FIG. 3 shows the spherical beverage pod of the embodiment shown in FIG. 2 within a brew chamber;

FIG. 4 shows the spherical beverage pod of the embodiment shown in FIG. 2 within a brew chamber according to another embodiment;

FIG. 5A illustrates a spherical beverage pod according to some embodiments;

FIG. 5B illustrates a spherical beverage pod according to other embodiments;

FIG. 6A shows the spherical beverage pod of the embodiment shown in FIG. 5A within a brew chamber;

FIG. 6B shows the spherical beverage pod of the embodiment shown in FIG. 5B within a brew chamber;

FIG. 7A shows the spherical beverage pod of the embodiment shown in FIG. 6A within a brew chamber according to another embodiment;

FIG. 7B shows the spherical beverage pod of the embodiment shown in FIG. 6B within a brew chamber according to another embodiment;

FIG. 8 illustrates a beverage pod according to some embodiments;

FIG. 9 depicts the beverage pod of FIG. 8 in a brew chamber according to some embodiments;

FIG. 10A shows a side view of a beverage pod according to some embodiments;

FIG. 10B shows a side view of a beverage pod according to other embodiments;

FIG. 11 shows a brew chamber shaped as a frustrum of a cone;

FIG. 12A shows the brew chamber of the embodiment of FIG. 11 including a beverage pod of the embodiment of FIG. 10B;

FIG. 12B shows the brew chamber of the embodiment of FIG. 11 including a beverage pod of the embodiment of FIG. 10A;

FIG. 13 illustrates another embodiment of a brew chamber shaped as the frustrum of a cone;

FIG. 14A shows an embodiment of a beverage pod for a beverage forming system;

FIG. 14B shows another embodiment of a beverage pod for a beverage forming system;

FIG. 14C shows another embodiment of a beverage pod for a beverage forming system;

FIG. 15 depicts a planform view of a beverage pod according to one embodiment;

FIG. 16A depicts a planform view of a beverage pod according to another embodiment;

FIG. 16B depicts a side view of the beverage pod of the embodiment of FIG. 16A;

FIG. 17 shows a schematic diagram of components of a beverage machine in an illustrative embodiment; and

FIG. 18 is a diagram for a method of forming a beverage.

### DETAILED DESCRIPTION

It should be understood that aspects of the invention are described herein with reference to the figures, which show illustrative embodiments. The illustrative embodiments described herein are not necessarily intended to show all embodiments in accordance with the invention, but rather are used to describe a few illustrative embodiments. Thus, aspects of the invention are not intended to be construed narrowly in view of the illustrative embodiments. In addition, it should be understood that aspects of the invention may be used alone or in any suitable combination with other aspects of the invention.

A beverage machine may be used to form a beverage by combining a beverage precursor liquid with a beverage ingredient. Single serving or small batch beverage machines are popular in the market. These beverage machines allow a user to prepare a small quantity of a beverage such as a single serving or a small batch of beverage. Multiple users can use the same machine to prepare different beverages, such as individual servings of different beverage types or beverage flavors quickly and without wasting unconsumed beverage. Different beverage types may have different brewing parameters in their preparation. For instance, drip-type coffee and espresso-type beverages may have different brewing pressures.

A single serving or small batch beverage machine may be used with a beverage pod to form a beverage such as tea, coffee, espresso, cocoa or other infusion type beverages. The beverage pod may include beverage ingredients such as suitably prepared coffee beans, tea leaves, etc. The beverage machine may form such beverages using a beverage precursor liquid, such as water, that may be combined with the beverage ingredients of the beverage pod under suitable conditions to form the beverage.

Conventional beverage pods are typically individually packaged servings of beverage ingredients, such as suitably ground coffee, to be combined with liquid and brewed. These individual packages of beverage ingredients may then be disposed after the beverage has been prepared.

The inventors have recognized and appreciated improvements in beverage machines, beverage ingredients packaging and methods of preparing a beverage. These improvements may reduce beverage ingredients packaging and/or waste resulting from the preparation of a beverage. Beverage ingredients may be portioned for use within a beverage machine without separate disposable packaging for each portion according to some embodiments disclosed herein.

A beverage machine may be capable of forming a variety of beverages. In some embodiments this may include a variety of single-serving beverages. It may be desirable for an individual beverage machine to form a variety of different beverage types, for instance coffee and espresso. Beverage types may be differentiated by substantial differences in beverage ingredients or in beverage preparation, or both. Different beverage types (e.g., the coffee and espresso) may be brewed with different brew parameters. Brew parameters include preparation characteristics used to form the beverage. Some beverage parameters may include: brewing temperature, brewing pressure, brewing time, fluid ingredient composition and volume and other parameters such as may be important to the preparation of certain beverages. Brewing parameters may include a quantitative portion of a brewing recipe or a step/process or sequence to be performed during the formation of a beverage.

According to some embodiments, a beverage machine may form drip-type coffee (or other beverages made using lower pressure liquid) and espresso-type beverages (or other beverages made using higher pressure liquid). The beverage machine may brew lower pressure beverages such as drip-type coffee near atmospheric pressure, at a pressure of less than 1 atm, at a pressure between 2-4 psig, or at a pressure below 2 psig, below 5 psig, below 10 psig, below 15 psig, and/or may be brewed under gravity driven flow conditions. The beverage machine may brew higher pressure beverages such as espresso (which may or may not additionally include a crema component) at a pressure greater than drip-type coffee, e.g. around 10-19 atmospheres or over a range of 100-300 psig or higher pressures.

The inventors have recognized and appreciated improvements in beverage forming arrangements wherein a beverage machine may determine one or more brewing parameters from the interaction of a beverage pod with the beverage machine.

According to some aspects discussed herein, a beverage machine may be configured to form a beverage with a package-less beverage pod. The package-less beverage pod may be able to hold its own shape, and thus may not require individual packaging to prevent dispersing of the beverage ingredients prior to use in forming a beverage. Such beverage pods may, for example, be in the form of a compacted tablet or a capsule (which may or may not be made of compacted materials). The beverage ingredients may be contained without separate, removable packaging. In some embodiments, the beverage ingredients of the package-less beverage pod have been compacted. In some embodiments, the package-less beverage pod may be bound together with a food-grade binder or with another beverage ingredient that promotes formation of the beverage tablet into a cohesive structure. Some package-less beverage pods may be formed through processing alone, such as by pressing, heating, or drying into the desired form.

In some embodiments, the package-less beverage pod may include a shell, such as a coating, disposed along the outer surface at the periphery of the pod. In some embodiments, the shell may bind the beverage ingredients within the interior of the pod. The beverage ingredients within the pod may be loose, such as loose ground coffee, or compacted. The shell may be a food grade binder, an alginate, edible, soluble, or any other suitable material. In some embodiments, the shell may serve as a barrier to reduce infiltration of oxygen and/or moisture such as to maintain freshness of the beverage ingredients. The shell or binder may be biodegradable. Material of the package-less beverage pod, including a shell of the pod if one is present, may directly contact some portion of the beverage machine, such as the brew chamber, before brewing the beverage, without intervening packaging in-between.

The package-less beverage pod may be configured to break into pieces during brewing or it may be configured to remain intact during brewing. The package-less beverage pod may be configured to at least partially or completely dissolve. In some embodiments, the package-less beverage pod may contain roasted coffee grounds (e.g. that remain behind after forming a beverage), soluble coffee, soluble materials, binders or other materials, and any combination of the above. The package-less beverage pod may be any suitable shape, such as a cylinder, a sphere, an ellipsoid, an elliptical prism, a teardrop shape, a frustrum of a cone, a cone or other shape.

In other embodiments, however, the beverage pod may be an individually packaged serving of beverage ingredients. The individual package of beverage ingredients may be removed from the beverage making machine and discarded after the beverage has been prepared. In some embodiments, at least a portion of or the entire packaging may be made of an edible, soluble, biodegradable, recyclable and/or compostable (e.g. home compostable and/or industrially compostable) material, or any combination thereof.

According to some embodiments, a single-serving beverage may fully utilize the beverage ingredients of a single beverage pod. A plurality of beverages may be formed from a corresponding plurality of beverage pods. According to other embodiments, a single beverage pod may brew any quantity of beverage, such as a pot of coffee.

According to some embodiments, a beverage forming arrangement may determine one or more brewing parameters through an interaction of a beverage pod and a beverage machine. A brewing parameter may be encoded within one or more dimensions of the beverage pod such that the beverage pod may apply a force to, or displace a portion of, the beverage machine to determine one or more brewing parameters for the beverage to be formed from the beverage pod. For example, in some embodiments, a range of dimensions or other measured physical characteristic may be associated with a first value for a brewing parameter, while a different range of diameters may be associated with a different, second value for a brewing parameter. The association between the measured characteristic and the brew parameter value may be stored locally at a beverage machine (e.g. in a look-up table) and/or in a remote resource (e.g. a server) that the beverage machine may communicate with, or any other suitable arrangement.

According to some embodiments, a beverage forming arrangement may include a beverage pod and a beverage machine configured to receive the beverage pod in a single orientation of the beverage pod. Receiving the beverage pod in a single orientation may allow the beverage machine to read an identifier where the identifier is located in a single location on the beverage pod. The identifier may then encode information to identify one or more brewing parameters. Maintaining consistent beverage pod orientation allows the identifier to be marked only once per pod and may increase reliability by presenting the identifier to the beverage machine in a consistent way to reduce potential errors in reading the identifier. In some embodiments, a single orientation beverage pod may be combined with dimensional encoding of one or more brewing parameters for greater redundancy.

Turning to the figures, specific non-limiting embodiments are described in further detail. It should be understood that the various systems, components, features, and methods described relative to these embodiments may be used either individually and/or in any desired combination as the disclosure is not limited to only the specific embodiments described herein.

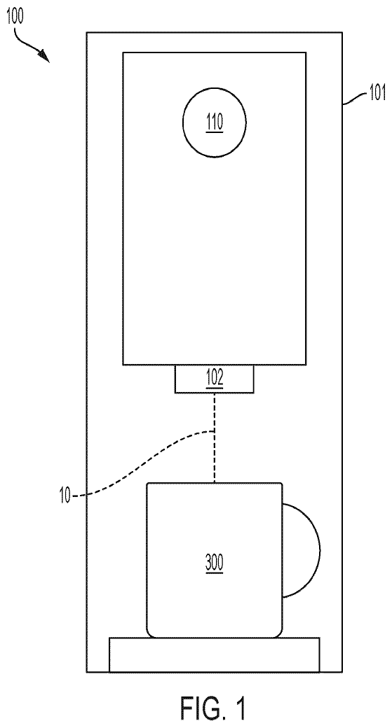

FIG. 1 depicts a beverage machine 100 according to some embodiments. The beverage machine 100 includes the beverage machine housing 101, a user interface 110, and a brew chamber 102. The beverage machine is illustrated in the process of brewing a beverage 10 (shown as a stream of beverage), emanating from the brew chamber 102 and directed into a container 300 (the container may not part of the beverage machine). The beverage machine 100 and a pod of beverage material (not visible) may form a beverage forming arrangement.

In some embodiments, a brew chamber may have a pod receptacle for receiving a beverage pod, and a brew chamber lid. The pod receptacle and the brew chamber lid may cooperate to enclose and retain a beverage pod. The pod receptacle and brew chamber lid may be moveable relative to one another (e.g., the brew chamber lid may move relative to the pod receptacle, the pod receptacle may be moveable relative to the brew chamber lid, or both) between an open configuration in which a beverage pod may be received into the brew chamber, and a closed configuration to enclose and retain a beverage pod. The brew chamber may be configured to be sealed in the closed configuration, e.g. may be watertight and/or airtight prior to the introduction of fluid to brew the beverage. A brew chamber lid should not be interpreted as being on any particular face of a brew chamber (e.g., the top) but may be on any face of the brew chamber, e.g. top, bottom, or any side. Fluid, including the precursor liquid, may be provided to a beverage pod from the brew chamber lid. A user may insert a beverage pod by opening the brew chamber lid, however other embodiments are contemplated where beverage pods may be loaded into the brew chamber without the need for a user to manually open the brew chamber lid, which may not be accessible or visible to the user in some embodiments. A brew chamber lid may open in any direction such as vertically, horizontally, or at any angle to a vertical or horizontal plane. A brew chamber lid may translate to open, pivot to open, or a combination of both. Likewise, the flow of fluid into, through, or from the brew chamber may be in any direction or combination of directions. A beverage machine may include one or more brew chambers.

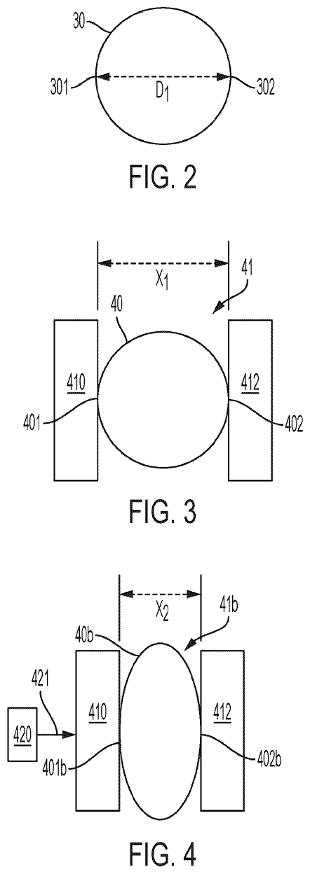

FIG. 2 shows a spherical beverage pod according to some embodiments. The spherical beverage pod 30 has a diameter D₁. The diameter D₁ may encode information related to the identity of the beverage pod or at least one brewing parameter. The spherical beverage pod 30 includes a first surface 301 and a second surface 302. The first surface 301 and the second surface 302 may be spherical caps or spherical domes that form non-overlapping regions at opposing sides or poles of the spherical beverage pod 30 (e.g., the first and second surfaces 301, 302 may be surfaces of opposing hemispheres of the sphere). In some embodiments, a beverage machine may contact the spherical pod at the first surface 301 and at the second surface 302. The first surface 301 and the second surface 302 may be deformed by contact with the brew chamber and/or brew chamber lid. The distance encoding information used to determine brewing parameters may be the diameter D₁, or it may be a position or displacement after a force has been applied to the beverage pod 30.

FIG. 3 shows the spherical beverage pod of the embodiment shown in FIG. 2 within a brew chamber. The beverage pod 40 is illustrated within a brew chamber 41 (only portions of which are shown). The beverage pod 40 is held between a brew chamber surface 412 and a brew chamber lid 410. The brew chamber 41 forms the space between the brew chamber surface 412 and the brew chamber lid 410 (other walls of the brew chamber are not shown). The beverage pod 40 may contact the brew chamber lid at a first surface 401, and the beverage pod may contact the brew chamber surface 412 at a second surface 402. As illustrated, the brew chamber is not distorting the beverage pod so that spacing X₁ is equivalent to the diameter D₁ of the unconstrained beverage pod illustrated in FIG. 2. The spacing X₁ may correspond to a specific beverage type such that when the brew chamber is configured as in FIG. 3, the beverage machine is configured for one or more brewing parameters for the beverage pod corresponding to the beverage type.

FIG. 4 shows the spherical beverage pod of the embodiment shown in FIG. 2 within a brew chamber according to another embodiment. The beverage pod 40b is illustrated within a brew chamber 41b (only portions of which are shown). The beverage pod 40b is held, compressed, and deformed between a brew chamber surface 412 and a brew chamber lid 410. The brew chamber 41b forms the space between the brew chamber surface 412 and the brew chamber lid 410 (other walls of the brew chamber are not shown). The beverage pod contacts the brew chamber lid at a first surface of the beverage pod 401b the beverage pod contacts the brew chamber surface 412 at a second surface of the beverage pod 402b. As illustrated, the brew chamber is distorting the beverage pod so that spacing X₂ is less than the diameter D₁ of the unconstrained beverage pod illustrated in FIG. 2. The spacing X₂ may correspond to a specific beverage type such that when the brew chamber is configured as in FIG. 4, the beverage machine is configured for one or more brewing parameters for the beverage pod corresponding to the beverage type. The beverage machine may apply a known or constant force between the first surface and the second surface. The beverage machine may include a force regulator (e.g. a tension regulator) 420 to provide a known, measured, or constant force 421 to the beverage pod 40b. Distance X₂ may be a function of the initial diameter D₁ of the unconstrained beverage pod illustrated in FIG. 2, the force applied by the tension or force regulator 420, and the mechanical properties of the beverage pod 40b. If the initial diameter and the applied force are constant, two different beverage pods corresponding to two different beverage types may have the same initial diameter but different X₂ values if the mechanical properties of the beverage pods differ. Hence different brewing parameters corresponding with the different beverage types may be encoded with the mechanical properties of the beverage pod. Different type beverage pods may not have different unconstrained sizes.

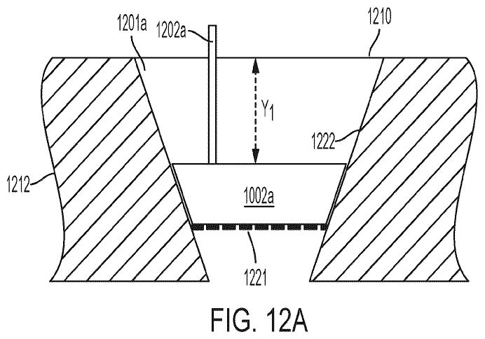

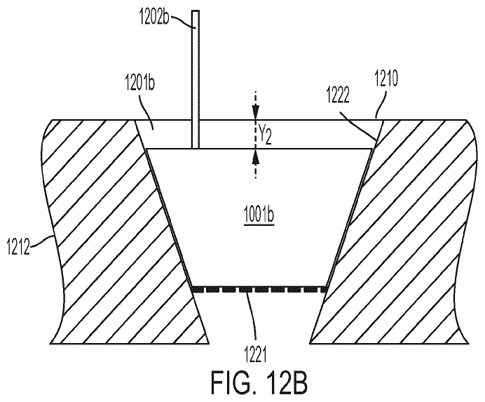

It should be noted that the brew chamber surface 412 and the brew chamber lid 410 are shown for illustrative purposes only and may contain additional features in the envisioned embodiments. For instance, a brew chamber lid may include hinges, latches, provisions for providing fluid into the brew chamber, etc. In some embodiments, the brew chamber lid may include features to interact with the beverage pod. Such features may protrude from the brew chamber lid. In some embodiments, some portion of the brew chamber lid may close to a consistent position (relative to the rest of the beverage machine, see FIGS. 12A, 12B) while a measuring portion of the brew chamber lid contacts the beverage pod. In some embodiments, the measuring portion of the brew chamber lid may be contact pins or other structures attached to the brew chamber lid and moveable therewith. Likewise, the brew chamber surface may be contoured to match the beverage pod or may include protrusions, seals etc. to contact the beverage pod in some embodiments. The brew chamber may close on the beverage pod in a horizontal orientation or a vertical orientation, or at some position between horizontal and vertical.

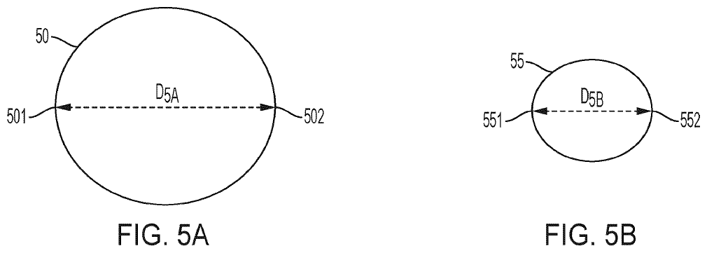

FIG. 5A illustrates a spherical beverage pod according to some embodiments. The spherical beverage pod 50 has a diameter D_{5A}. The diameter D_{5A} may encode information related to the identity of the beverage pod or at least one brewing parameter. The spherical beverage pod 50 includes a first surface 501 and a second surface 502. The first surface 501 and the second surface 502 may be spherical caps or spherical domes that form non-overlapping regions at opposing sides or poles of the spherical beverage pod 50 (e.g., the first and second surfaces 501, 502 may be surfaces of opposing hemispheres of the sphere). The first surface 501 and the second surface 502 may be deformed by contact with the brew chamber and/or brew chamber lid. In some embodiments, a beverage machine may contact the spherical pod at the first surface 501 and at the second surface 502. The distance encoding information used to determine brewing parameters may be the diameter D_{5A}, or it may be a position or displacement after a force has been applied to the beverage pod 50.

FIG. 5B illustrates a spherical beverage pod according to some embodiments. The spherical beverage pod 55 has a diameter D_{5B}. The diameter D_{5B} may encode information related to the identity of the beverage pod or at least one brewing parameter. The spherical beverage pod 55 includes a first surface 551 and a second surface 552. The first surface 551 and the second surface 552 may be spherical caps or spherical domes that form non-overlapping regions at opposing sides or poles of the spherical beverage pod 55 (e.g., the first and second surfaces 551, 552 may be surfaces of opposing hemispheres of the sphere). The first surface 551 and the second surface 552 may be deformed by contact with the brew chamber and/or brew chamber lid. In some embodiments, a beverage machine may contact the spherical pod at the first surface 551 and at the second surface 552. The distance encoding information used to determine brewing parameters may be the diameter D_{5B}, or it may be a position or displacement after a force has been applied to the beverage pod 55. Comparison with FIG. 5A shows that beverage pod 55 is smaller than beverage pod 50 such that D_{5B}<D_{5A}. Beverage pod 55 and beverage pod 50 may correspond to different beverage types. For instance, beverage pod 50 may be a coffee pod and beverage pod 55 may be an espresso pod.

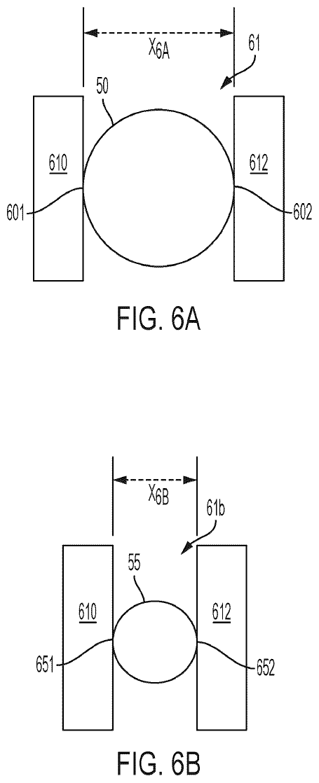

FIG. 6A shows the spherical beverage pod of the embodiment shown in FIG. 5A within a brew chamber. The beverage pod 50 is illustrated within a brew chamber 61 (only portions of which are shown). The beverage pod 50 is held between a brew chamber surface 612 and a brew chamber lid 610. The brew chamber 61 forms the space between the brew chamber surface 612 and the brew chamber lid 610 (other walls of the brew chamber are not shown). The beverage pod 50 may contact the brew chamber lid at a first surface 601, and the beverage pod may contact the brew chamber surface 612 at a second surface 602. As illustrated, the brew chamber is not distorting the beverage pod so that spacing X_{6A} is equivalent to the diameter DsA of the unconstrained beverage pod illustrated in FIG. 5A. The spacing X_{6A} may correspond to a specific beverage type such that when the brew chamber is configured as in FIG. 6A, the beverage machine is configured for one or more brewing parameters for the beverage pod corresponding to the beverage type.

FIG. 6B shows the spherical beverage pod of the embodiment shown in FIG. 5B within a brew chamber. The beverage pod 55 is illustrated within a brew chamber 61b (only portions of which are shown). The beverage pod 55 is held between a brew chamber surface 612 and a brew chamber lid 610. The brew chamber 61b forms the space between the brew chamber surface 612 and the brew chamber lid 610 (other walls of the brew chamber are not shown). The beverage pod may contact the brew chamber lid at a first surface 651, and the beverage pod may contact the brew chamber surface 612 at a second surface 652. As illustrated, the brew chamber is not deforming the beverage pod so that spacing X_{6B} is equivalent to the diameter D_{5B} of the unconstrained beverage pod illustrated in FIG. 5B. The spacing X_{6A} may correspond to a specific beverage type such that when the brew chamber is configured as in FIG. 6B, the beverage machine is configured for one or more brewing parameters for the beverage pod corresponding to the beverage type.

It may be observed from the embodiments of FIGS. 6A and 6B that the brew chamber includes the same brew chamber lid 610 and brew chamber surface 612. As such, the same beverage machine may be configured to accommodate different size beverage pods (50 and 55). According to some embodiments, beverage pods 50 and 55 may correspond with different beverage types, and the resulting separation distances X_{6A} and X_{6B} may produce different beverage pod identifications and at least one correspondingly different brewing parameter.

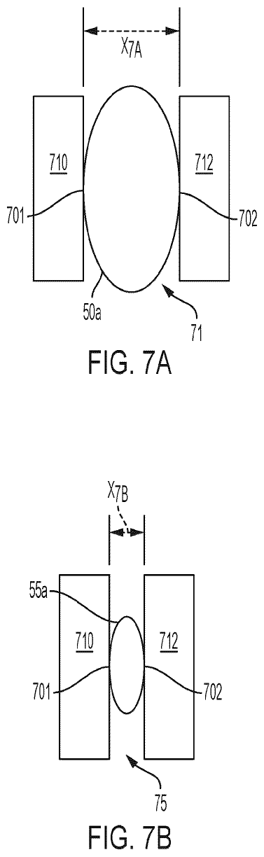

FIG. 7A shows the spherical beverage pod of the embodiment shown in FIG. 6A within a brew chamber according to another embodiment. The beverage pod 50a is illustrated within a brew chamber 71 (only portions of which are shown). The beverage pod 50a is held, compressed, and deformed between a brew chamber surface 712 and a brew chamber lid 710. The brew chamber 71 forms the space between the brew chamber surface 712 and the brew chamber lid 710 (other walls of the brew chamber are not shown). The beverage pod contacts the brew chamber lid at a first surface of the beverage pod 701 the beverage pod contacts the brew chamber surface 712 at a second surface of the beverage pod 702. As illustrated, the brew chamber is distorting the beverage pod so that spacing X_{7A} is less than the diameter DSA of the unconstrained beverage pod illustrated in FIG. 5A. The spacing X_{7A} may correspond to a specific beverage type such that when the brew chamber is configured as in FIG. 7A, the beverage machine is automatically configured for one or more brewing parameters for the beverage pod corresponding to the beverage type. The beverage machine may apply a known or constant force between the first surface and the second surface. The beverage machine may include a force regulator to provide a known, measured, or constant force to the beverage pod 50a. Distance X_{7A} may be determined by the initial diameter D_{5A} of the unconstrained beverage pod illustrated in FIG. 5A, the force applied to the beverage pod 50a, and the mechanical properties of the beverage pod. Two beverage pods of the same initial diameter may have different X_{7A} values due to differing mechanical properties of the different beverage pods.

FIG. 7B shows the spherical beverage pod of the embodiment shown in FIG. 6B within a brew chamber according to another embodiment. The beverage pod 55a is illustrated within a brew chamber 75 (only portions of which are shown). The beverage pod 55a is held, compressed, and deformed between a brew chamber surface 712 and a brew chamber lid 710. The brew chamber 75 forms the space between the brew chamber surface 712 and the brew chamber lid 710 (other walls of the brew chamber are not shown). The beverage pod contacts the brew chamber lid at a first surface of the beverage pod 701 the beverage pod contacts the brew chamber surface 712 at a second surface of the beverage pod 702. As illustrated, the brew chamber is distorting the beverage pod so that spacing X_{7B} is less than the diameter D_{5B} of the unconstrained beverage pod illustrated in FIG. 5B. The spacing X_{7B} may correspond to a specific beverage type such that when the brew chamber is configured as in FIG. 7B, the beverage machine is configured for one or more brewing parameters for the beverage pod corresponding to the beverage type. The beverage machine may apply a known or constant force between the first surface and the second surface. The beverage machine may include a force regulator to provide a known, measured, or constant force to the beverage pod 55a. Distance X_{7B} may be determined by the initial diameter D_{5B} of the unconstrained beverage pod illustrated in FIG. 5B, the force applied to the beverage pod 55a, and the mechanical properties of the beverage pod. Two beverage pods of the same initial diameter may have different X_{7B} values due to differing mechanical properties of the beverage pods.

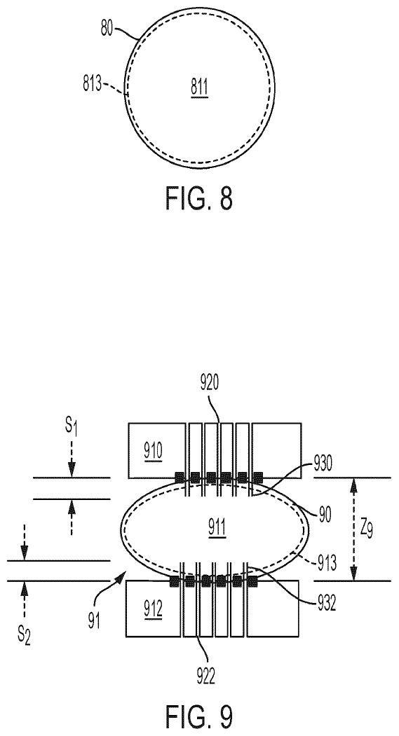

FIG. 8 illustrates a beverage pod according to some embodiments. Beverage pod 80 includes beverage materials 811 contained by a shell 813. The shell 813 may be a coating, such as a binder, moisture barrier, and/or air barrier applied to the beverage materials. The shell 813 may be bound to the beverage materials 811 at all locations along the inside surface of the shell. Beverage materials may also be termed beverage ingredients. The formed shape of beverage materials may be termed the body of the beverage pod. The body of beverage materials 811 may be bound to and inseparable from the shell 813. The beverage materials 811 may substantially fill the entire inside volume of the shell. In some embodiments, the shell may differ from the remainder of the beverage materials only by the degree of compaction or other processing parameter and may not include any distinct ingredient or change in composition. A beverage pod in the form of a tablet may not include a shell and may be of a uniform composition with uniform properties throughout.

According to some embodiments, a beverage pod may include a body made of one or more beverage materials, an outer wall, a first surface, and a second surface. The first surface and the second surface are separated by a distance and a brewing parameter is encoded in the distance. The first surface and the second surface may be planar surfaces or curved surfaces. In some embodiments (e.g., spherical beverage pods), the first surface and the second surface may be a spherical dome or spherical cap that may exist at the opposing poles of a sphere (e.g., the surfaces of opposing hemispheres of the sphere). The separation distance may be a diameter of the beverage pod.

The outer wall is the outer periphery of the beverage pod. The outer wall may be composed of beverage materials and may have the same composition as the body of beverage materials. In some embodiments, the outer wall may have the same composition as the body of beverage materials but may have a greater degree of compaction such as to be more rigid and less porous than the body. The outer wall may additionally be made more rigid with heat or by drying the beverage materials into the desired shape. The outer wall may include a shell. A hardened outer wall formed of beverage ingredients (such as by drying, heating, compaction, etc.) may be one form of the shell. The material properties of the hardened outer wall may vary continuously from the outer periphery into the body such that there may be no distinct inner boundary between the shell and the body. In some embodiments, the shell may include additional ingredients. The shell may include a binder. The binder may join together and seal pores within particles of beverage material (e.g., ground coffee etc). The shell may be applied by coating onto beverage material such that the shell includes both beverage material and binder. A shell coating may be applied by spraying, dipping, applying in-mold, or other techniques for applying a coating. In some embodiments, the shell may be thinner than an average particle size of the beverage material. In some embodiments, another beverage ingredient may be used as the shell such that the shell may dissolve and form the beverage.

According to some embodiments, the beverage pod is without individual packaging. Beverage pods may lack individually packaging, and packaging may not form any part of the beverage pod as it is received into the beverage machine. The shell of the beverage pod, if present, may be inseparable from the beverage materials contained within the pod, is bonded to the beverage materials within the pod and is not packaging. In some embodiments, the beverage pod is configured to be received within a beverage machine without packaging such that the at least one beverage ingredient of the body directly contacts the beverage machine prior to forming a beverage without intervening packaging.

FIG. 9 depicts a pod of beverage material in a brew chamber according to some embodiments. Beverage pod 90 may be the beverage pod of the embodiment illustrated in FIG. 8. The beverage pod 90 is held between a brew chamber wall 912 and a brew chamber lid 910. Each of the brew chamber wall 912 and brew chamber lid 910 include a plurality of tubes, configured to pass into the brew chamber 91. The tubes include passages 920 and 922 that permit fluid communication with the brew chamber and/or beverage pod 90. Tubes 930 protrude a distance S₁ from the brew chamber lid 910. Tubes 932 protrude a distance S₂ from the brew chamber wall 912. The tubes may penetrate the beverage pod such that the ends of the tubes may penetrate through the shell 913 of the beverage pod (if present) and into the beverage material 911. A beverage fluid ingredient may pass from one set of tubes through the beverage pod and into the other set of tubes to brew a beverage. In some embodiments, fluid may enter the beverage pod 90 from tubes 930 in the brew chamber lid 910. In other embodiments, fluid may enter the beverage pod 90 from tubes 932 in the brew chamber wall 912 and exit through tubes 930 in the brew chamber lid. In some embodiments only one set of tubes may be present. Tube penetration distances S₁ and S₂ may or may not be equal. In some embodiments, the tubes may be configured to penetrate the shell 913 of the beverage pod 90 while leaving the beverage pod intact. In other embodiments, the tubes may be configured to break the beverage pod before brewing, such as with a tablet beverage pod.

As illustrated in FIG. 9, the beverage pod is being compressed such as by a constant force applied through a portion of the brew chamber lid 910. Distance Z₉ may correspond to one or more brewing parameters for a particular type of beverage, such that inserting the beverage pod 90 in the brew chamber 91 and closing the brew chamber lid 910 may configure the beverage machine to brew a beverage from pod 90 with one or more appropriate brewing parameters to produce a beverage of acceptable quality. Brew parameters may be encoded in the distance Z₉, may be determined by scanning an identifier on the beverage pod, may be entered by the user, or tailored by a user to match the tastes of the user, or brew parameters may be entered in other suitable ways.

Although the brew chamber is illustrated in a vertical orientation with a predominately vertical brewing direction, this disclosure is not to be limited to brew chamber orientation or brewing direction. The brew chamber of FIG. 9 may be oriented horizontally or at any angle.

According to some embodiments, the beverage pod may form a seal with the brew chamber lid 910 and/or the brew chamber wall 912. The seal may be formed by compliance of the beverage pod 90 or some portion of it such as the shell 913. The seal may only form when the beverage pod is wet in some instances. The seal may not be intended to prevent all leakage but rather to limit leakage and/or to direct brewed beverage to leave the brew chamber. In some embodiments, an additional seal may be provided as a portion of the brew chamber wall 912 or the brew chamber lid 910. The additional seal may be of rubber, silicone, or other suitable material.

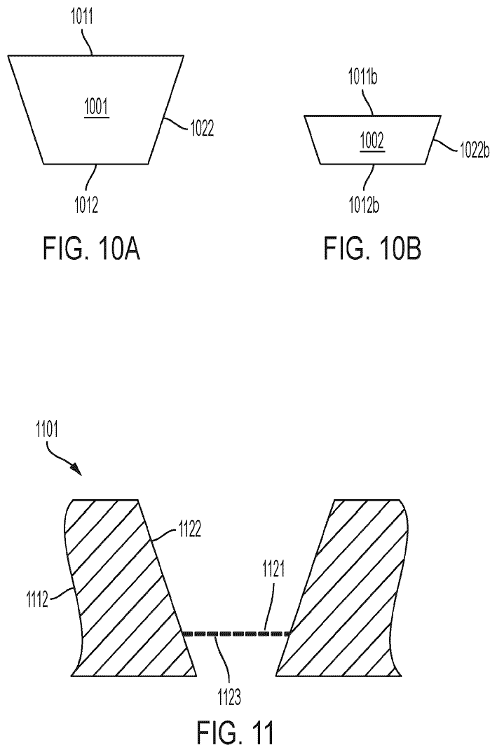

FIG. 10A shows a side view of a beverage pod according to some embodiments. Beverage pod 1001 is shaped as a frustrum of a cone. The beverage pod includes a first surface 1011 and a second surface 1012. The first surface is parallel to the second surface and separated by a distance. The first surface 1011 and the second surface 1012 are circular faces. The beverage pod may be configured to fit a brew chamber fit to the shape of the frustrum of the cone. The beverage pod may interact with the brew chamber along a conical surface 1022 and/or the second surface 1012.

FIG. 10B shows a side view of a beverage pod according to some embodiments. Beverage pod 1002 is shaped as a frustrum of a cone. The beverage pod includes a first surface 1011b and a second surface 1012b. The first surface is parallel to the second surface and separated by a distance. The first surface 1011b and the second surface 1012b are circular faces. The beverage pod of FIG. 10B is configured to fit the same brew chamber as the embodiment of FIG. 10A but to encode one or more different brewing parameters resulting from the different spacings of the first surface and the second surface (or alternatively different diameters of the first surface 1011 of beverage pod 1001 and the first surface 1011b of beverage pod 1002). The second surface 1012 of beverage pod 1001 and the second surface 1012b of beverage pod 1002 may be the same diameter, that is the smaller diameter of the frustrums may be the same and they may index to the same datum on the brew chamber. Likewise, the cone angle of the conical surface 1022 of beverage pod 1001 may be the same as the cone angle of the conical surface 1022b of 1002. Beverage pod 1001 and beverage pod 1002 may therefore fit the same brew chamber in a similar fashion, differing in the location of the first surface (1011 or 1011b for beverage pods 1001 or 1002 respectively) relative to a point in the brew chamber.

FIG. 11 shows a brew chamber shaped as a frustrum of a cone. Brew chamber 1101 is configured to receive beverage pods shaped as the frustrum of a cone such as the embodiments depicted in FIGS. 10A and 10B. The brew chamber includes a brew chamber wall 1122 including a plurality of holes 1123. The conical brew chamber wall 1122 is configured to receive and/or support the conical surface of an appropriately shaped beverage pod. The brew chamber 1101 is located in a portion of a beverage machine 1112.

FIG. 12A shows the brew chamber of the embodiment of FIG. 11 including a beverage pod of the embodiment of FIG. 10B. The brew chamber 1201a is located within a portion of a beverage machine 1212. The beverage pod 1002a is in the form of a frustrum of a cone. The beverage pod 1002a sits in the brew chamber 1201a supported by a conical surface 1222 of the brew chamber acting on a mating conical surface of beverage pod 1002a. The beverage pod 1002a is additionally supported by brew chamber surface 1221 which includes a plurality of holes to allow the passage of fluid including brewed beverage. A brew chamber lid 1210 encloses the brew chamber. A contact pin 1202a is a portion of the brew chamber lid 1210. The contact pin extends from the rest of the brew chamber lid 1210 and contacts a facing surface of the beverage pod. The contact pin 1202a is displaced by the interaction of the beverage pod 1002a and the contact pin. The distance Y₁ and/or the related displacement of the contact pin 1202a, encode information to determine at least one brewing parameter for the beverage pod 1002a that has been inserted into the brew chamber 1201a.

FIG. 12B shows the brew chamber of the embodiment of FIG. 11 including a beverage pod of the embodiment of FIG. 10A. The brew chamber 1201b is located within a portion of a beverage machine 1212. Beverage pod 1001b in the form of a frustrum of a cone, sits in the brew chamber 1201b and is supported by a conical surface 1222 of the brew chamber acting on a mating conical surface of beverage pod 1001b. Beverage pod 1001b is additionally supported by brew chamber surface 1221 which includes a plurality of holes to allow the passage of fluid including the passage of brewed beverage from the brew chamber. The brew chamber lid 1210 encloses the brew chamber. In some embodiments, a contact pin 1202b may be coupled to a portion of the brew chamber lid 1210. The contact pin extends into the brew chamber from the brew chamber lid 1210 and contacts a facing surface of the beverage pod 1001b. The contact pin 1202b is displaced by the interaction of the beverage pod 1001b and the contact pin. The distance Y₂ and/or the related displacement of the contact pin 1202b encode information to determine at least one brewing parameter for the beverage pod 1001b that has been inserted into the brew chamber 1201b. Comparison with FIG. 12A will show that the distance Y₂<Y₁ and the contact pin 1202b is displaced farther upward than contact pin 1202a due to the smaller Y₂ distance. It should be noted that the contact pin is the same structure and the difference in nomenclature 1202a/1202b is to distinguish the change in position. The position of the contact pin (1202a or 1202b) may identify the beverage pod. The identification may determine the beverage type corresponding to the beverage pod and may set the appropriate brew parameter or parameters. The brew parameters may be set electronically after reading the position of the contact pin or mechanically by linkages connected to the contact pin or by any other suitable method.

According to some embodiments, the contact pin may discharge fluid into the brew chamber or into a beverage pod itself. The contact pin may include a needle which may pierce or penetrate the beverage pod. The needle may discharge a fluid beverage ingredient. Although only one contact pin is illustrated, a plurality of contact pins may be present.

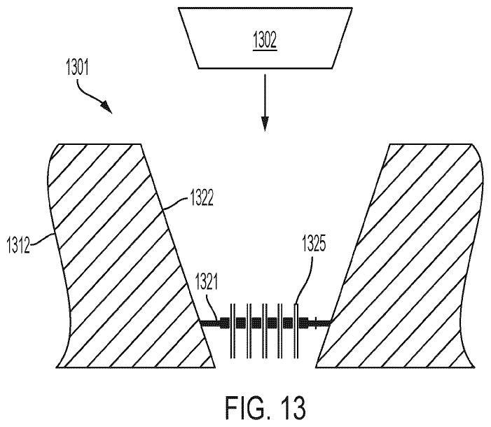

FIG. 13 illustrates another embodiment of a brew chamber shaped as the frustrum of a cone. Brew chamber 1301 is formed in a portion of a beverage machine 1312. The brew chamber includes a conical surface 1322 configured to mate with a conical surface on a beverage pod 1302 shown during insertion (arrow) into brew chamber 1301. The brew chamber additionally includes a brew chamber surface 1321. Tubes 1325 protruding from the brew chamber surface 1321 may pierce or penetrate the beverage pod 1302. The tubes may convey brewed beverage from the brew chamber or they may convey a fluid beverage ingredient into the brew chamber. A brew chamber lid is not illustrated in FIG. 13, however a brew chamber lid may fit and function as illustrated in FIGS. 12A and 12B. The brew chamber lid may include a measuring pin to determine one or more primary brewing parameters as in FIGS. 12A and 12B. The measuring pin and/or other portions of the brew chamber lid may compress and/or deform the beverage pod 1302. In some embodiments, the beverage pod 1302 may be fractured by the interaction of the tubes 1325 and the brew chamber lid. In other embodiments, the beverage pod may remain intact during brewing. Additional tubes may be present in the brew chamber lid and may pierce the beverage pod 1302 as discussed for tubes 932.

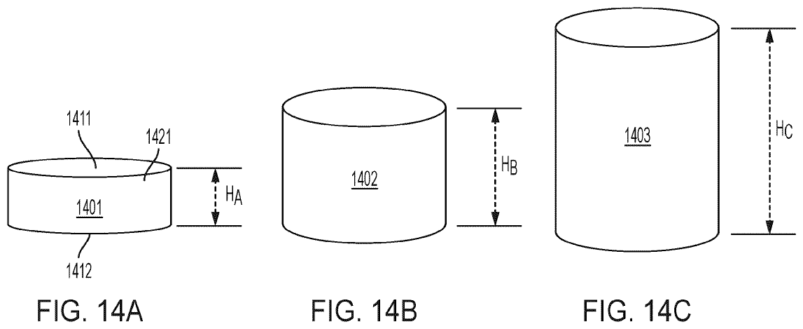

FIG. 14A shows another embodiment of a beverage pod for a beverage forming system. Beverage pod 1401 includes a first surface 1411 and a second surface 1412 and beverage materials 1421. The first surface 1411 is displaced from the second surface 1412 by a distance HA. The beverage pod 1401 may be a beverage tablet or a capsule. The beverage pod 1401 may include a shell. In some embodiments, the beverage materials 1421 within the beverage pod, such as forming the body of the beverage pod, may be softer and/or less compacted that beverage materials near or at the outer wall. In other embodiments, the beverage materials within the beverage pod are uniformly compacted. The beverage pod 1401 may be coated to form a shell. A beverage machine may penetrate the beverage pod such as with tubes similar to previously described embodiments. Beverage may be brewed by passing fluid through the beverage pod between the first surface 1411 and the second surface 1412 (in either direction) or radially or in any combination.

FIGS. 14B and 14C depict other embodiments of the beverage pod of FIG. 14A, alike in every way except for having different distances H_{B} and H_{C} between surfaces respectively in beverage pods 1402 and 1403 of FIGS. 14B and 14C. Beverage pods 1401, 1402, and 1403 may be brewed by the same beverage machine in the same brew chamber. The distances H_{A}, H_{B} and H_{C} may correspond to three different beverage types. Each distance may encode brewing parameters for the respective beverage type. A user may insert one of beverage pods 1401, 1402, or 1403 into a beverage machine and the beverage machine may determine one or more primary brewing parameters appropriate for the inserted beverage pod.

According to some embodiments, a primary brewing parameter may be correlated to the volume of the beverage pod. In embodiments such as those of FIGS. 14A-14C, with a uniform cross-sectional area, one or more primary brewing parameters may be correlated with the height or thickness of a beverage pod. The beverage machine may be configured to be tolerant of minor variation between beverage pods, such as may occur in manufacturing. For instance, different beverage types may be correlated to at least two unique non-overlapping volume ranges, with one beverage type corresponding to each volume range. A beverage machine may be configured to identify the volume range of a first beverage pod to distinguish the first beverage pod from a second beverage pod of a different non-overlapping volume range. The volume range may alternatively be expressed as a tolerance of pod dimensions. The tolerance ranges of each distinct pod type may be non-overlapping to reduce potential for ambiguity.

According to some aspects, a brew chamber is shaped to receive a beverage pod of a shape corresponding to a shape of the brew chamber. The brew chamber is shaped to allow the beverage pod to be received into the brew chamber in a single orientation of the beverage pod. For instance, a user may be able to insert a beverage pod into a brew chamber in a single orientation. A single allowable insertion orientation may be useful for locating an identifier in a single location such that a reader in the beverage machine may find the identifying marking in the same position and orientation to expedite reading/interpretation of the marking. Such an identifier may be used to identify a pod of beverage material or a brewing parameter or recipe for the same.

In some embodiments, it may be beneficial to include a single insertion orientation with a measurement of beverage pod size/deformation distance. While a single insertion orientation may enable scanning an identifier, occasionally the identifier may be damaged or may not scan properly for any reason. If one or more primary brewing parameters are additionally encoded within the size or displacement of the beverage pod, a beverage machine may prepare a beverage of suitable quality even if an identifier fails to scan. This may enhance redundance or decrease customer frustration such as from receiving an improperly formed beverage or from needing to replace a beverage pod that fails to scan.

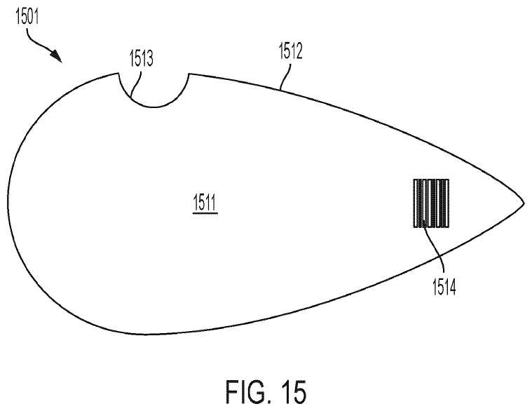

FIG. 15 depicts a planform view of a beverage pod according to one embodiment. Beverage pod 1501 includes a first surface 1511 and a perimeter 1512. An identifier 1514 is included on the beverage pod 1501. The identifier 1514 is shown as a bar code. The identifier may also be a QR code or any other suitable pattern or code. The identifier may include brewing parameters including at least one primary brewing parameter. The identifier may alternatively (or additionally) include an identity of the beverage pod that may be used to look up brewing parameters including one or more primary brewing parameters. The identifier may be read by a reader. The reader may be part of the beverage machine and may be a barcode reader, QR reader, etc. as appropriate. The placement of the identifier in FIG. 15 is for illustrative purposes only and may not represent the actual placement of identifiers which may be located at any convenient location.

The beverage pod 1501 has a teardrop shape as viewed in FIG. 15, the teardrop shape having the perimeter 1512. The beverage pod 1501 includes a notch 1513 in perimeter 1512. The notch, in combination with the overall shape of the beverage pod may limit possible insertion orientations of the beverage pod into a mating brew chamber. For instance, the brew chamber may be shaped as the negative of the beverage pod 1501, including the notch 1513 the brew chamber being only slightly larger than beverage pod 1501 so that the beverage pod will fit in the brew chamber in only one orientation. In some embodiments, a reader may be located in the beverage machine and positioned to read the identifier 1514 on the beverage pod. Promoting a consistent insertion orientation of pods may help to place the identifier in position to be read by the reader. The identifier may be positioned in like position and orientation on all similar beverage pods such that a reader positioned to read one identifier on one beverage pod would be positioned to read the identifiers on any similar beverage pod. This may reduce a need to print the identifier in more than one location on a beverage pod and may also reduce reading errors associated with reading misaligned identifiers etc.

First surface 1511 of beverage pod 1501 may be a planar face. As illustrated, there is no plane of symmetry for beverage pod 1501 that intersects with a plane containing the first surface 1511. This lack of symmetry enables the beverage pod to fit a similarly shaped brew chamber in only a single orientation of the beverage pod with respect to the brew chamber. According to some embodiments, a beverage pod includes a body made of one or more beverage ingredients, an outer wall, and a first surface. The first surface is a planar face and the beverage pod is asymmetric about any plane intersecting a plane containing the first surface. Asymmetry about any plane intersecting the first surface may limit the beverage pod to insertion within a brew chamber in a single orientation.

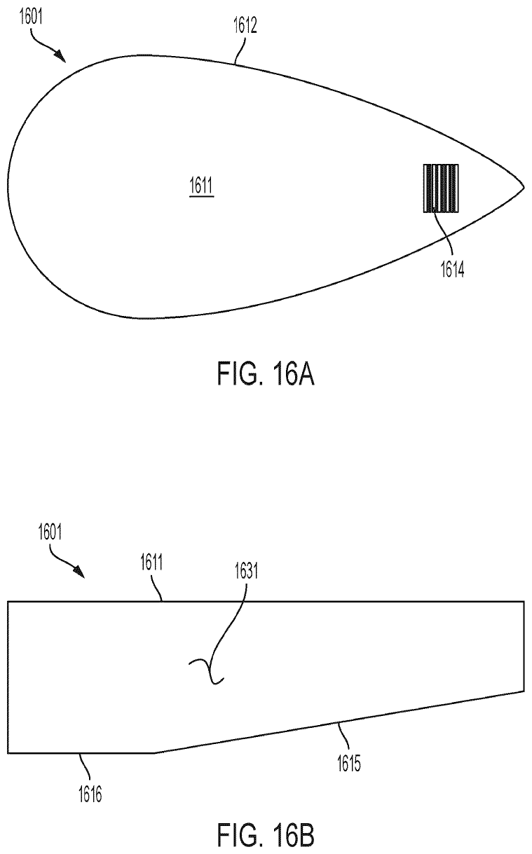

FIG. 16A depicts a planform view of a beverage pod according to another embodiment. Beverage pod 1601 includes a first surface 1611 and a perimeter 1612. An identifier 1614 is included on the beverage pod 1601. The identifier 1614 is shown as a bar code but the identifier may also be a QR code or any other suitable pattern or code. The identifier may include brewing parameters including at least one primary brewing parameter. The identifier may alternatively (or additionally) include an identity of the beverage pod that may be used to look up brewing parameters including one or more primary brewing parameters. Beverage pod 1601 has a teardrop shape.

FIG. 16B depicts a side view of the beverage pod of the embodiment of FIG. 16A. The outer surface 1631 corresponds with the perimeter 1612 of the pod shown in FIG. 16A. Second surface 1616 is a planar surface parallel to the first surface. Third surface 1615 is another planar surface. The plane containing the third surface 1615 will intersect a plane containing the first surface 1611 at an acute angle. The presence of the second surface may help to restrict insertion of the beverage pod to a single orientation of the beverage pod when the beverage pod is inserted into a similarly shaped brew chamber mating with the outer surface 1631 and the third surface 1615.

In addition to the embodiments described, insertion may be limited to a single orientation by through holes, blind holes, or pockets with mating geometry within an appropriate brew chamber.

A variety of beverage pod shapes are contemplated. A beverage pod may be a sphere, or a portion of sphere such as a hemisphere. A beverage pod may be a frustrum of a cone. A beverage pod may be a cylinder or prism. A beverage pod may be shaped as a round right circular cylinder (see FIGS. 14A-14C), an elliptical cylinder, an ellipsoid, a teardrop shape (see FIGS. 15-16B) or other shape. The beverage pod may have a first surface and a second surface, the first surface being parallel to the second surface and displaced from the second surface by a distance. The first surface and the second surface may be of the same size and shape, for example as in a right circular cylinder, or the size and/or shape of the first surface and the second surface may differ. For instance, a frustrum of a cone may have two parallel faces of the same (e.g. circular) shape but having different sizes. A beverage pod may lack any plane of symmetry in some embodiments. A beverage pod may include holes or other features.

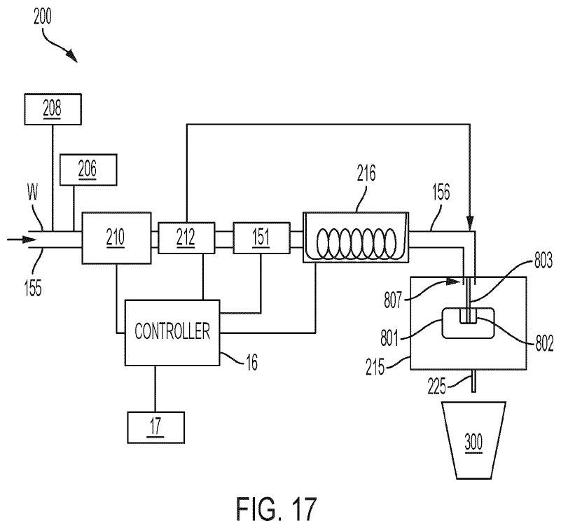

FIG. 17 shows a schematic block diagram of various components that may be included in a beverage machine 200 in one illustrative embodiment. Those of skill in the art will appreciate that a beverage machine 200 may be configured in a variety of different ways, and thus aspects of the invention should not be narrowly interpreted as relating only to one type of beverage machine. In this embodiment, a precursor liquid (e.g. hot or cold water) may be supplied from a liquid supply (e.g. a water reservoir) to a brew chamber 215. A beverage pod 801 comprising one or more beverage ingredients (e.g. coffee grounds, soluble coffee, tea leaves, etc.) may be included for use in forming the beverage. The beverage pod 801 may comprise a compacted beverage tablet in which its beverage ingredients 211 have been compacted into a tablet form.

A liquid supply W may supply beverage precursor liquid to a brew chamber 215. The source W may have any suitable arrangement, e.g., may provide liquid from a removable or fixed storage tank, a mains water supply or other source. Thus, in some cases, the liquid provided from the source W may vary in temperature by a wide degree depending on various factors, such as time of year, a temperature of a room in which the beverage machine 200 is located, etc. For example, if the source W is a reservoir that is filled by a user, the temperature of liquid in the reservoir may vary between room temperature (e.g., if liquid sits in the reservoir for an extended time) and a cooler temperature (e.g., if the reservoir has just been filled with water that is dispensed from a tap).

A pump 210 may drive liquid from the liquid supply W through a valve 151 through a liquid conditioner 216 (e.g. a heater, chiller, and/or carbonator), into a supply line 156 through a fluid port 807 and into the brew chamber 215 where a beverage pod 801 is held.

Following introduction of beverage precursor liquid into the brew chamber 215, the beverage pod 801 may be mixed with the precursor liquid to form a desired beverage. The beverage may then be dispensed to a container 300 (e.g., a cup or a carafe) using a beverage machine dispenser outlet 225.

The pump 210 and/or valve 151 may be in electrical communication with a controller 16 and/or a user interface. In some embodiments, the pump 210 may serve as the sole fluid driving source that moves liquid from the liquid supply W to the brew chamber 215.

In some embodiments, an air valve 208 may be provided between the liquid supply W and the pump 210. The air valve 208 may allow air trapped within the liquid line 155 to escape the flow path prior to entering the pump 210. This may contribute to more efficient operation of the pump 210 and any downstream components, or reduce a likelihood of damage to the pump 210 or any downstream components. The air valve 208 may be in electrical communication with the controller 16 and/or a user interface.

In some embodiments, a pressure relief valve 212 may be provided between the pump 210 and the valve 151. The pressure relief valve 212 may allow liquid from the pump 210 to bypass the valve 151 in the event that excess pressure builds between the pump 210 and the valve 151. Liquid from the pressure relief valve 212 may be allowed to exit the beverage machine 200 through the brew chamber 215, or any other appropriate outlet of the machine. In this way, the pressure relief valve 212 may prevent a build-up of excess pressure between the pump 210 and the valve 151. This configuration may prevent damage to the pump 210, the valve 151, and/or other system components, particularly in the event that the valve 151 or another downstream component becomes blocked or clogged.

In some embodiments, a liquid level detector 206 may be provided in the beverage machine 200 near the liquid supply W, or in some embodiments, in the liquid supply W itself. In some embodiments, the liquid level detector may be a conductivity probe positioned near an outlet of the liquid supply W. The liquid level detector may sense when the liquid in the liquid supply W is below a threshold fill level, such as when the liquid supply is empty or nearly empty. In other embodiments, the liquid level detector may include a microswitch with an attached float that rises with liquid level in a tank of the liquid supply W. In another embodiment, the liquid level detector may detect a capacitance change associated with one or more liquid levels in the tank, may use an optical emitter/sensor arrangement (such as an LED and photodiode) to detect a change in liquid level, may use a pressure sensor, may use a floating magnet and Hall effect sensor to detect a level change, and others. Thus, the liquid level detector is not necessarily limited to a conductive probe configuration. Moreover, the liquid level detector may include two or more different types of sensors to detect different levels in a tank of a liquid supply. For example, a pressure sensor may be used to detect liquid at a first dispense level, while a conductive probe may be used to detect liquid at a second, different dispense level. The liquid level detector 206 may be in electrical communication with the controller 16 and/or a user interface.

In some embodiments, the liquid conditioner 216 is a heater comprising any appropriate type of heater, boiler, or heat exchanger. For example, in some embodiments, the liquid conditioner 216 may be a flow-through heater that has a relatively small volume, e.g., a tube with associated heating element to heat liquid in the tube. Examples of flow-through heaters include a flat flow through heater, a spiral flow through heater, a U-shaped flow through heater, or any other type of heater. In some embodiments, the heater may be a heating element that heats a hot water tank. The heater may be in thermal communication with the hot water tank, e.g. inside the hot water tank in direct contact with the water inside the tank, or in a non-water contact arrangement in which the heater is provided outside the tank or embedded within the tank wall. The liquid conditioner 216 may be in electrical communication with the controller 16 and/or a user interface.

Of course, heating of the liquid is not necessary, and instead (or additionally) the liquid conditioner may comprise a chiller to cool the liquid, a carbonator to carbonate the liquid, or otherwise condition the liquid in a way that alters the volume of liquid supplied to the brew chamber.

The controller 16 may include a programmed processor and/or other data processing device along with suitable software or other operating instructions, one or more memories (including non-transient storage media that may store software and/or other operating instructions), temperature and liquid level sensors, pressure sensors, input/output interfaces (such as a user interface 17), communication buses or other links, a display, switches, relays, triacs, or other components necessary to perform desired input/output or other functions. A user interface 17 may be included to provide information to a user and/or receive information from a user, such as buttons, a touch screen, a voice command module (including a microphone to receive audio information from a user and suitable software to interpret the audio information as a voice command), a visual display, one or more indicator lights, a speaker, and so on.

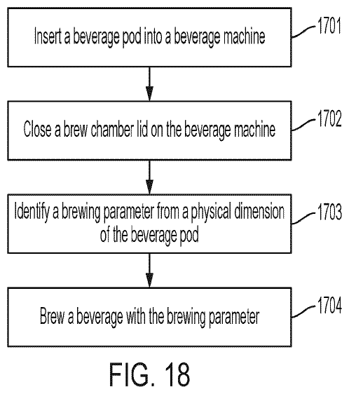

FIG. 18 illustrates a diagram for a method of forming a beverage. The method to form the beverage includes: inserting a beverage pod into a beverage machine in step 1701; closing a brew chamber lid on the beverage machine in step 1702; determining a physical dimension of the beverage pod in step 1703; and brewing a beverage with a brewing parameter associated with the physical dimension of the beverage pod in step 1704. According to some embodiments, closing a brew chamber may include a beverage machine automatically closing the brew chamber. In other cases, a user may operate a lever or other user control to close (or open) the brew chamber without seeing the brew chamber and potentially without awareness of what components the lever or user control is actuating inside the beverage machine.

According to some embodiments, the method additionally includes: displacing a portion of the brew chamber with a beverage pod; measuring the displacement distance of the displaced portion of the brew chamber; and forming a beverage using a brew parameter associated with the measured displacement distance. In some cases, the displacement distance may be measured after compressing and deforming a beverage pod. The displacement distance may therefore be partially a function of material properties of the beverage pod. Material properties may be an elastic modulus or a stiffness of the beverage pod.

According to some embodiments, the method for forming a beverage may include applying a force to compress the beverage pod into the brew chamber; forming a seal between the beverage pod and the brew chamber; injecting fluid into the beverage pod to brew a beverage; and withdrawing brewed beverage from the beverage pod. The beverage pod may be identified before or after compressing the beverage pod. The applied force may be a constant applied force or a force applied with a known and/or repeatable magnitude for a given displacement.

According to other embodiments, the method of forming a beverage may additionally include reading an identifier on the beverage pod; and determining the brew parameter at least in part from the information obtained from the identifier. Reading an identifier may augment or replace determining the brewing parameter based on a size or displacement of the beverage pod. Any number of parameters and other information, including information unrelated to brewing, may be encoded in the identifier.

With any of the described methods, the primary brewing parameter may be one of several primary brewing parameters. Any number of primary brewing parameters may be encoded.

Although aspects of the present disclosure may be described with respect to single serving beverage machines, this disclosure is not meant to be limiting to single serving beverage machines or to the preparation of any quantity of beverage and may be applied to any beverage machine which may prepare any quantity of beverage or any number of beverage servings during a beverage forming operation.

The above-described embodiments of the technology described herein can be implemented in any of numerous ways. For example, the embodiments may be implemented using hardware, software or a combination thereof. When implemented in software, the software code can be executed on any suitable processor or collection of processors, whether provided in a single computer or distributed among multiple computers. Such processors may be implemented as integrated circuits, with one or more processors in an integrated circuit component, including commercially available integrated circuit components known in the art by names such as CPU chips, GPU chips, microprocessor, microcontroller, or co-processor. Alternatively, a processor may be implemented in custom circuitry, such as an ASIC, or semicustom circuitry resulting from configuring a programmable logic device. As yet a further alternative, a processor may be a portion of a larger circuit or semiconductor device, whether commercially available, semi-custom or custom. As a specific example, some commercially available microprocessors have multiple cores such that one or a subset of those cores may constitute a processor. Though, a processor may be implemented using circuitry in any suitable format.

Further, it should be appreciated that a computer may be embodied in any of a number of forms, such as a rack-mounted computer, a desktop computer, a laptop computer, or a tablet computer. Additionally, a computer may be embedded in a device not generally regarded as a computer but with suitable processing capabilities, including a Personal Digital Assistant (PDA), a smart phone or any other suitable portable or fixed electronic device.

Also, a computer may have one or more input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computer may receive input information through speech recognition or in other audible format.

Such computers may be interconnected by one or more networks in any suitable form, including as a local area network or a wide area network, such as an enterprise network or the Internet. Such networks may be based on any suitable technology and may operate according to any suitable protocol and may include wireless networks, wired networks or fiber optic networks.

Also, the various methods or processes outlined herein may be coded as software that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

In this respect, the embodiments described herein may be embodied as a computer readable storage medium (or multiple computer readable media) (e.g., a computer memory, one or more floppy discs, compact discs (CD), optical discs, digital video disks (DVD), magnetic tapes, flash memories, circuit configurations in Field Programmable Gate Arrays or other semiconductor devices, or other tangible computer storage medium) encoded with one or more programs that, when executed on one or more computers or other processors, perform methods that implement the various embodiments discussed above. As is apparent from the foregoing examples, a computer readable storage medium may retain information for a sufficient time to provide computer-executable instructions in a non-transitory form. Such a computer readable storage medium or media can be transportable, such that the program or programs stored thereon can be loaded onto one or more different computers or other processors to implement various aspects of the present disclosure as discussed above. As used herein, the term “computer-readable storage medium” encompasses only a non-transitory computer-readable medium that can be considered to be a manufacture (i.e., article of manufacture) or a machine. Alternatively or additionally, the disclosure may be embodied as a computer readable medium other than a computer-readable storage medium, such as a propagating signal.

The terms “program” or “software” are used herein in a generic sense to refer to any type of computer code or set of computer-executable instructions that can be employed to program a computer or other processor to implement various aspects of the present disclosure as discussed above. Additionally, it should be appreciated that according to one aspect of this embodiment, one or more computer programs that when executed perform methods of the present disclosure need not reside on a single computer or processor, but may be distributed in a modular fashion amongst a number of different computers or processors to implement various aspects of the present disclosure.

Computer-executable instructions may be in many forms, such as program modules, executed by one or more computers or other devices. Generally, program modules include routines, programs, objects, components, data structures, etc. that perform particular tasks or implement particular abstract data types. Typically the functionality of the program modules may be combined or distributed as desired in various embodiments.

Also, data structures may be stored in computer-readable media in any suitable form. For simplicity of illustration, data structures may be shown to have fields that are related through location in the data structure. Such relationships may likewise be achieved by assigning storage for the fields with locations in a computer-readable medium that conveys relationship between the fields. However, any suitable mechanism may be used to establish a relationship between information in fields of a data structure, including through the use of pointers, tags or other mechanisms that establish relationship between data elements.

Various aspects of the present disclosure may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments.

Also, the embodiments described herein may be embodied as a method, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

While the present teachings have been described in conjunction with various embodiments and examples, it is not intended that the present teachings be limited to such embodiments or examples. On the contrary, the present teachings encompass various alternatives, modifications, and equivalents, as will be appreciated by those of skill in the art. Accordingly, the foregoing description and drawings are by way of example only.

1. A beverage machine comprising:
a brew chamber configured to receive a beverage pod to form a beverage, the brew chamber having a pod receptacle and a brew chamber lid, wherein the brew chamber lid is configured to close on the pod receptacle to encapsulate the beverage pod inside the brew chamber,
wherein interaction of the brew chamber and beverage pod establishes a brewing parameter for the beverage machine for brewing a beverage from the beverage pod.

2. The beverage machine of claim 1, wherein the brew chamber further comprises a contact pin, and wherein the contact pin is configured to contact the beverage pod and to be displaced by a distance due to contact with the beverage pod, wherein the displacement distance of the contact pin establishes the brewing parameter.

3. (canceled)

4. The beverage machine of claim 1, wherein the brew chamber lid is configured to compress and deform a beverage pod when the brew chamber lid is closed on the beverage pod, and wherein the deformation distance resulting from the compression of the beverage pod establishes a brewing parameter for the beverage machine.

5. (canceled)

6. The beverage machine of claim 1, further comprising the beverage pod, wherein the beverage pod has a first surface and a second surface, the first surface being parallel to the second surface and displaced from the second surface by a distance.

7. The beverage machine of claim 6, wherein the distance separating the first surface from the second surface corresponds to the brewing parameter.

8. The beverage machine of claim 1, further comprising the beverage pod, wherein the beverage pod is a sphere.

9. The beverage machine of claim 8, wherein the brew parameter is established by a diameter of the spherical beverage pod.

10. The beverage machine of claim 1, further comprising the beverage pod, wherein the beverage pod is shaped as a frustrum of a cone.

11. The beverage machine of claim 1, further comprising the beverage pod, wherein the beverage pod is shaped as one of: an ellipsoid, an elliptical cylinder, a teardrop.

12. The beverage machine of claim 1, further comprising the beverage pod, wherein the beverage pod includes a shell disposed around a periphery of the beverage pod, the shell configured to retain solid beverage material within the beverage pod.

13. The beverage machine of claim 1, wherein the brewing parameter is brewing pressure.

14. The beverage machine of claim 1, wherein a first beverage pod contains coffee beverage material and a second beverage pod contains espresso beverage material and wherein the beverage machine is configured to distinguish the first beverage pod from the second beverage pod via interaction of the brew chamber with the beverage pod.

15. (canceled)

16. The beverage machine of claim 4, wherein the beverage pod is compressed along a horizontal direction.

17. The beverage machine of claim 4, wherein the beverage pod is compressed along a vertical direction.

18. A beverage pod, comprising:
a body made of one or more beverage materials, the body having an outer wall defining an outer surface of the beverage pod; and
a first surface, wherein the first surface is a planar face, wherein the beverage pod is asymmetric about any plane intersecting a plane containing the first surface.

19-31. (canceled)

32. A method of forming a beverage comprising:
inserting a beverage pod into a beverage machine;
closing a brew chamber lid on the beverage machine;
determining a physical dimension of the beverage pod; and
brewing a beverage with a brewing parameter associated with the physical dimension of the beverage pod.

33. The method of claim 32, wherein the step of determining a physical dimension of the beverage pod comprises:
displacing a portion of the brew chamber with the beverage pod; and
measuring the displacement distance of the displaced portion of the brew chamber.

34. The method of claim 32, the method further comprising:
applying a force to compress the beverage pod into the brew chamber;
forming a seal between the beverage pod and the brew chamber;
injecting fluid into the beverage pod to brew a beverage; and
dispensing brewed beverage from the beverage pod.

35. The method of claim 32, wherein the brewing parameter comprises pressure.

36. The method of claim 32, wherein the brewing parameter comprises one of temperature or beverage volume.
